(19) United States
(12) Patent Application Publication
(10) Pub. No.: US 2024/0049232 A1
(43) Pub. Date: Feb. 8, 2024

(54) JOINT ADAPTATION BETWEEN CONTROL CHANNELS AND OTHER CONFIGURATIONS

(71) Applicant: QUALCOMM Incorporated, San Diego, CA (US)

(72) Inventors: Linhai HE, San Diego, CA (US); Wooseok NAM, San Diego, CA (US); Yuchul KIM, San Diego, CA (US); Huilin XU, Temecula, CA (US)

(21) Appl. No.: 18/326,836

(22) Filed: May 31, 2023

Related U.S. Application Data
(60) Provisional application No. 63/394,767, filed on Aug. 3, 2022.

(51) Int. Cl. H04W 72/20; H04W 24/02; H04W 72/12

(52) U.S. Cl. CPC H04W 72/20; H04W 24/02; H04W 72/12

(57) ABSTRACT

Methods, systems, and devices for wireless communications are described. In a wireless communication system, a user equipment (UE) may receive an indication of multiple search space set groups (SSSGs), where a respective SSSG may be associated with a respective parameter set. Parameters in a parameter set may be power-saving parameters, reliability parameters, or a combination thereof. The UE may receive control signaling indicating a switch from a first SSSG to a second SSSG. The UE may switch from the first SSSG to the second SSSG and apply a first parameter set to the second SSSG, where the second SSSG is associated with (e.g., mapped to) to the first parameter set. In some examples, the SSSGs may be associated with respective scheduling request configuration groups (SRCGs), which the UE may use to transmit SRs to the network entity.

### CROSS REFERENCE

The present Application for Patent claims the benefit of U.S. Provisional Patent Application No. 63/394,767 by HE et al., entitled “JOINT ADAPTATION BETWEEN CONTROL CHANNELS AND OTHER CONFIGURATIONS,” filed Aug. 3, 2022, assigned to the assignee hereof, and expressly incorporated by reference herein.

### FIELD OF TECHNOLOGY

The following relates to wireless communications, including joint adaptation between control channels and other configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support joint adaptation between control channels and other configurations. For example, the described techniques provide for joint adaptation between control channels and other configurations, which may enable a user equipment (UE) to apply parameters to search space set groups (SSSGs) to increase reliability or power savings for different configurations. In some examples, the UE may receive an indication of a set of multiple SSSGs, where each SSSG may be associated with (e.g., mapped to) a respective parameter set of a configuration of the UE. A parameter set may include power saving parameters, reliability parameters, or a combination thereof. The UE may receive a signal (e.g., control signaling from a network entity) indicating a switch from a first SSSG to a second SSSG of the multiple SSSGs. The UE may switch from using the first SSSG to using the second SSSG, and the UE may apply a parameter set to the second SSSG. Based on a mapping between SSSGs and parameter sets of the configurations, the UE may utilize particular parameter sets for different SSSGs to meet or exceed performance targets.

A method for wireless communication at a UE is described. The method may include receiving a message indicating a set of multiple SSSGs, where respective SSSGs of the set of multiple SSSGs are associated with respective parameter sets of a set of multiple configurations of the UE, receiving control signaling indicating a switch from a first SSSG of the set of multiple SSSGs to a second SSSG of the set of multiple SSSGs, and applying a parameter set of a first configuration of the set of multiple configurations of the UE to the second SSSG based on the control signaling, where the second SSSG is associated with the first configuration.

An apparatus for wireless communication at a UE is described. The apparatus may include a processor, memory coupled with the processor, and one or more instructions stored in the memory and executable by the processor to cause the apparatus to, based on the one or more instructions, receive a message indicating a set of multiple SSSGs, where respective SSSGs of the set of multiple SSSGs are associated with respective parameter sets of a set of multiple configurations of the UE, receive control signaling indicating a switch from a first SSSG of the set of multiple SSSGs to a second SSSG of the set of multiple SSSGs, and apply a parameter set of a first configuration of the set of multiple configurations of the UE to the second SSSG based on the control signaling, where the second SSSG is associated with the first configuration.

Another apparatus for wireless communication at a UE is described. The apparatus may include means for receiving a message indicating a set of multiple SSSGs, where respective SSSGs of the set of multiple SSSGs are associated with respective parameter sets of a set of multiple configurations of the UE, means for receiving control signaling indicating a switch from a first SSSG of the set of multiple SSSGs to a second SSSG of the set of multiple SSSGs, and means for applying a parameter set of a first configuration of the set of multiple configurations of the UE to the second SSSG based on the control signaling, where the second SSSG is associated with the first configuration.

A non-transitory computer-readable medium storing code for wireless communication at a UE is described. The code may include instructions executable by a processor to receive a message indicating a set of multiple SSSGs, where respective SSSGs of the set of multiple SSSGs are associated with respective parameter sets of a set of multiple configurations of the UE, receive control signaling indicating a switch from a first SSSG of the set of multiple SSSGs to a second SSSG of the set of multiple SSSGs, and apply a parameter set of a first configuration of the set of multiple configurations of the UE to the second SSSG based on the control signaling, where the second SSSG is associated with the first configuration.

In some examples of the method, apparatuses, and non-transitory computer-readable medium described herein, receiving the message may include operations, features, means, or instructions for receiving the message indicating the set of multiple SSSGs and indicating the set of multiple configurations, where the set of multiple configurations includes a set of multiple power saving parameter sets, a set of multiple reliability parameter sets, or any combination thereof, and where the respective SSSGs may be associated with a respective power saving parameter set or a respective reliability parameter set.

In some examples of the method, apparatuses, and non-transitory computer-readable medium described herein, receiving the message may include operations, features, means, or instructions for receiving the message indicating the set of multiple configurations, where a power saving parameter set of the set of multiple configurations includes a discontinuous reception (DRX) timer parameter, a downlink offset parameter, an uplink offset parameter, an antenna parameter, or any combination thereof.

In some examples of the method, apparatuses, and non-transitory computer-readable medium described herein, receiving the message may include operations, features, means, or instructions for receiving the message indicating the set of multiple configurations, where a reliability parameter set of the set of multiple configurations includes a repetition parameter, a reference signal parameter, a transmission configuration indicator (TCI) parameter, or any combination thereof.

Some examples of the method, apparatuses, and non-transitory computer-readable medium described herein may further include operations, features, means, or instructions for receiving the control signaling indicating the switch from the first SSSG to the second SSSG based on a change in traffic and applying the parameter set to the second SSSG based on the control signaling, where the second SSSG may be associated with the first configuration, and where the parameter set includes a power saving parameter set.

Some examples of the method, apparatuses, and non-transitory computer-readable medium described herein may further include operations, features, means, or instructions for receiving the control signaling indicating the switch from the first SSSG to the second SSSG based on a change in channel quality and applying the parameter set to the second SSSG based on the control signaling, where the second SSSG may be associated with the first configuration, and where the parameter set includes a reliability parameter set.

In some examples of the method, apparatuses, and non-transitory computer-readable medium described herein, receiving the message may include operations, features, means, or instructions for receiving the message indicating the set of multiple SSSGs, where the respective SSSGs may be associated with respective scheduling request configuration groups (SRCGs) of a set of multiple SRCGs.

Some examples of the method, apparatuses, and non-transitory computer-readable medium described herein may further include operations, features, means, or instructions for receiving downlink control information (DCI) indicating the switch from the first SSSG to the second SSSG and applying a first SRCG to the second SSSG based on the control signaling, where the second SSSG may be associated with the first SRCG.

In some examples of the method, apparatuses, and non-transitory computer-readable medium described herein, receiving the message may include operations, features, means, or instructions for receiving the message indicating the set of multiple SSSGs, where two or more SSSGs may be associated with a respective SRCG.

Some examples of the method, apparatuses, and non-transitory computer-readable medium described herein may further include operations, features, means, or instructions for transmitting a scheduling request (SR) via a channel associated with the SR, where the SR and the channel may be indicated in a respective SRCG.

A method for wireless communication at a network entity is described. The method may include transmitting a message indicating a set of multiple SSSGs, where respective SSSGs of the set of multiple SSSGs are associated with respective parameter sets of a set of multiple configurations of a UE and transmitting control signaling indicating a switch from a first SSSG of the set of multiple SSSGs to a second SSSG of the set of multiple SSSGs.

An apparatus for wireless communication at a network entity is described. The apparatus may include a processor, memory coupled with the processor, and one or more instructions stored in the memory and executable by the processor to cause the apparatus to, based on the one or more instructions, transmit a message indicating a set of multiple SSSGs, where respective SSSGs of the set of multiple SSSGs are associated with respective parameter sets of a set of multiple configurations of a UE and transmit control signaling indicating a switch from a first SSSG of the set of multiple SSSGs to a second SSSG of the set of multiple SSSGs.

Another apparatus for wireless communication at a network entity is described. The apparatus may include means for transmitting a message indicating a set of multiple SSSGs, where respective SSSGs of the set of multiple SSSGs are associated with respective parameter sets of a set of multiple configurations of a UE and means for transmitting control signaling indicating a switch from a first SSSG of the set of multiple SSSGs to a second SSSG of the set of multiple SSSGs.

A non-transitory computer-readable medium storing code for wireless communication at a network entity is described. The code may include instructions executable by a processor to transmit a message indicating a set of multiple SSSGs, where respective SSSGs of the set of multiple SSSGs are associated with respective parameter sets of a set of multiple configurations of a UE and transmit control signaling indicating a switch from a first SSSG of the set of multiple SSSGs to a second SSSG of the set of multiple SSSGs.

In some examples of the method, apparatuses, and non-transitory computer-readable medium described herein, transmitting the message may include operations, features, means, or instructions for transmitting the message indicating the set of multiple SSSGs and indicating the set of multiple configurations, where the set of multiple configurations includes a set of multiple power saving parameter sets, a set of multiple reliability parameter sets, or any combination thereof, and where the respective SSSGs may be associated with a respective power saving parameter set or a respective reliability parameter set.

In some examples of the method, apparatuses, and non-transitory computer-readable medium described herein, transmitting the message may include operations, features, means, or instructions for transmitting the message indicating the set of multiple configurations, where a power saving parameter set of the set of multiple configurations includes a DRX timer parameter, a downlink offset parameter, an uplink offset parameter, an antenna parameter, or any combination thereof.

In some examples of the method, apparatuses, and non-transitory computer-readable medium described herein, transmitting the message may include operations, features, means, or instructions for transmitting the message indicating the set of multiple configurations, where a power saving parameter set of the set of multiple configurations includes a repetition parameter, a reference signal parameter, a TCI parameter, or any combination thereof.

In some examples of the method, apparatuses, and non-transitory computer-readable medium described herein, transmitting the control signaling may include operations, features, means, or instructions for transmitting the control signaling indicating the switch from the first SSSG to the second SSSG based on a change in traffic.

In some examples of the method, apparatuses, and non-transitory computer-readable medium described herein, transmitting the control signaling may include operations, features, means, or instructions for transmitting the control signaling indicating the switch from the first SSSG to the second SSSG based on a change in channel quality.

In some examples of the method, apparatuses, and non-transitory computer-readable medium described herein, transmitting the message may include operations, features, means, or instructions for transmitting the message indicating the set of multiple SSSGs, where the respective SSSGs may be associated with respective SRCGs of a set of multiple SRCGs.

Some examples of the method, apparatuses, and non-transitory computer-readable medium described herein may further include operations, features, means, or instructions for transmitting DCI indicating the switch from the first SSSG to the second SSSG.

In some examples of the method, apparatuses, and non-transitory computer-readable medium described herein, transmitting the message may include operations, features, means, or instructions for transmitting the message indicating the set of multiple SSSGs, where two or more SSSGs may be associated with a respective SRCG.

Some examples of the method, apparatuses, and non-transitory computer-readable medium described herein may further include operations, features, means, or instructions for receiving an SR via a channel associated with the SR, where the SR and the channel may be indicated in a respective SRCG.

### BRIEF DESCRIPTION OF THE DRAWINGS

FIG. 1 illustrates an example of a wireless communications system that supports joint adaptation between control channels and other configurations in accordance with one or more aspects of the present disclosure.

FIG. 2 illustrates an example of a wireless communications system that supports joint adaptation between control channels and other configurations in accordance with one or more aspects of the present disclosure.

FIG. 3 illustrates an example of a mapping scheme that supports joint adaptation between control channels and other configurations in accordance with one or more aspects of the present disclosure.

FIG. 4 illustrates an example of a process flow that supports joint adaptation between control channels and other configurations in accordance with one or more aspects of the present disclosure.

FIGS. 5 and 6 show block diagrams of devices that support joint adaptation between control channels and other configurations in accordance with one or more aspects of the present disclosure.

FIG. 7 shows a block diagram of a communications manager that supports joint adaptation between control channels and other configurations in accordance with one or more aspects of the present disclosure.

FIG. 8 shows a diagram of a system including a device that supports joint adaptation between control channels and other configurations in accordance with one or more aspects of the present disclosure.

FIGS. 9 and 10 show block diagrams of devices that support joint adaptation between control channels and other configurations in accordance with one or more aspects of the present disclosure.

FIG. 11 shows a block diagram of a communications manager that supports joint adaptation between control channels and other configurations in accordance with one or more aspects of the present disclosure.

FIG. 12 shows a diagram of a system including a device that supports joint adaptation between control channels and other configurations in accordance with one or more aspects of the present disclosure.

FIGS. 13 through 17 show flowcharts illustrating methods that support joint adaptation between control channels and other configurations in accordance with one or more aspects of the present disclosure.

### DETAILED DESCRIPTION

A network entity may communicate with a user equipment (UE) via a downlink control channel. In some examples, the network entity may transmit a physical downlink control channel (PDCCH), where a configuration (e.g., parameters or parameters sets) of the PDCCH may dynamically adapt to traffic. For example, the network entity may configure multiple search space set groups (SSSGs), which may also be referred to as search space set switching groups, with different parameters in which the UE may receive and decode a PDCCH. Some parameters of the SSSGs may be associated with performance targets related to, for example, improved signaling throughput, power savings, and reliability, among other performance targets. In some cases, the network entity may transmit dynamic, layer 1 (L1)-based signaling to the UE (e.g., downlink control information (DCI)) indicating or instructing the UE to switch between different SSSGs to utilize some performance target or objective.

However, the network entity may use such L1-based signaling for downlink control channel transmissions, excluding some other parameters from being changed or switched based on the performance targets. For example, the UE may switch some other parameters, such as a periodicity parameter for a scheduling request (SR), to improve power efficiency, however the network entity may use radio resource control (RRC) signaling to reconfigure these parameters. An RRC reconfiguration procedure may be slower than the dynamic, L1-based signaling used for downlink control channels, which may result in higher latency and low throughput for the UE. In addition, transmitting additional dynamic signaling to reconfigure or switch parameters related to other signaling aside from downlink control channel transmissions may increase signaling overhead and power consumption as the UE may have more signaling to decode.

The techniques described herein support joint adaptation between control channels and other configurations, such as SR configurations, which may enable a UE to apply parameters to SSSGs to increase reliability or power savings for different configurations. In some examples, the UE may receive an indication of a set of multiple SSSGs, where each SSSG may be associated with (e.g., mapped to) a respective parameter set of a configuration of the UE (e.g., an SR configuration). A parameter set may include power saving parameters, reliability parameters, or a combination thereof. The UE may receive a signal (e.g., control signaling) from a network entity (e.g., DCI) indicating a switch from a first SSSG to a second SSSG of the multiple SSSGs. The UE may switch from using the first SSSG to using the second SSSG, and the UE may apply a parameter set to the second SSSG based on the control signaling, where the second SSSG may be associated with the first parameter set. As such, based on a mapping between SSSGs and parameter sets, the UE may utilize particular parameter sets for different SSSGs, which may result in reliability and power saving improvements, among other performance benefits.

Aspects of the disclosure are initially described in the context of wireless communications systems. Aspects of the disclosure are then described in the context of mapping schemes and process flows. Aspects of the disclosure are further illustrated by and described with reference to apparatus diagrams, system diagrams, and flowcharts that relate to joint adaptation between control channels and other configurations.

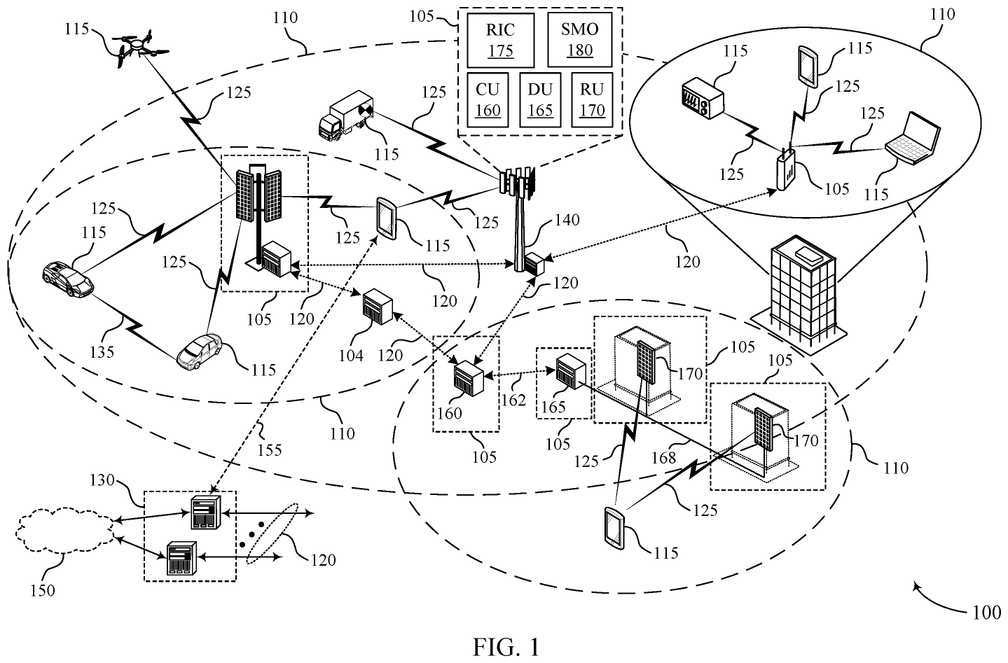

FIG. 1 illustrates an example of a wireless communications system 100 that supports joint adaptation between control channels and other configurations in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support joint adaptation between control channels and other configurations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (states)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A network entity 105 may transmit a downlink control channel, such as a PDCCH, to a UE 115. A PDCCH configuration (e.g., a quantity of occasions per period, a periodicity) may adapt dynamically to traffic. In some examples, the network entity 105 may configure multiple SSSGs (e.g., two sets of search spaces) for different purposes, where the UE 115 may monitor for PDCCH transmissions in an SSSG. For example, the network entity 105 may configure an SSSG for high throughput (e.g., a search space in the SSSG may have a relatively short periodicity so the UE 115 receives more PDCCH transmissions and increases throughput), UE power efficiency (e.g., a search space in the SSSG may have a relatively long periodicity to enable the UE 115 to enter a sleep mode between two control channel monitoring occasions), or other performance targets.

In some examples, the UE 115 may switch between throughput and power efficiency PDCCH configurations based on a timer or dynamic, L1 signaling from the network entity 105. For example, the UE 115 may switch SSSGs each time a preconfigured timer is reset (e.g., each time new data is transmitted to the UE 115). Alternatively, the network entity 105 may transmit DCI to the UE 115 indicating that the UE 115 is to switch SSSGs. For example, if no data is scheduled for transmission to the UE 115 in a given time period, the network entity 105 may transmit dynamic signaling indicating that the UE 115 is to switch from an SSSG configured for high throughput to an SSSG configured for UE power efficiency, and accordingly, the UE 115 may enter a sleep mode or perform some other power saving behavior.

In some cases, the network entity 105 may use such dynamic, L1-based switching only for downlink control channel configurations (e.g., PDCCH configurations). However, other configurations relevant to throughput and power savings, such as SR configurations, cross-slot scheduling configurations, HARQ feedback configurations, and reference signal configurations, among others, may additionally benefit from being changed or switched to meet or exceed different performance targets. The network entity 105 may use an RRC reconfiguration procedure (e.g., layer 3 (L3) signaling) to switch such configurations, which may be slower than L1-based signaling (e.g., an RRC reconfiguration procedure may occur over 10 ms or more, while a DCI indication may occur across one slot, which may be 0.5 ms to 1 ms).

For example, in downlink, cross-slot scheduling, the UE 115 may use a K0 parameter that indicates a time gap between receiving scheduling DCI for a physical downlink shared channel (PDSCH) and receiving the actual PDSCH. If the UE 115 is in a high throughput scenario, the UE 115 may use a relatively short K0 value to receive more PDSCHs, faster, thus increasing throughput. If the UE 115 is initially using a cross-slot scheduling configuration for power savings, the network entity 105 may transmit RRC signaling to the UE 115 to switch to a high throughput cross-slot scheduling configuration that utilizes a short K0 value. However, the RRC signaling may occur over a long enough time period such that the UE 115 may miss or drop one or more PDSCH transmissions, resulting in high latency and decreased throughput.

In some other examples, the UE 115 may transmit an SR over a physical uplink control channel (PUCCH) and monitor a PDCCH for an uplink grant from the network entity 105, the uplink grant indicating for the UE 115 to transmit some data via an uplink. An SR configuration may include one occasion per periodicity without any adaptation to a traffic pattern or a particular control channel. Thus, with a short PUCCH periodicity, the UE 115 may transmit frequent SRs. If the PUCCH periodicity is relatively long, the network entity 105 may use an RRC reconfiguration procedure to change the SR configuration and decrease the PUCCH periodicity. However, coupling between uplink and downlink transmissions and the slow speed of the RRC reconfiguration may result in wasted PUCCH resources. For example, after the UE 115 transmits an SR via the PUCCH, the UE 115 may expect to receive the uplink grant on the PDCCH. How fast the UE 115 may receive the uplink grant depends on the availability of PDCCH monitoring occasions, regardless of whether the SR configuration has a periodicity that matches that of a PDCCH monitoring occasion. As such, if the PDCCH is optimized for power efficiency with a short periodicity, the SR configuration is configured for high throughput with a long periodicity, and the network entity 105 may use the RRC reconfiguration procedure to reconfigure the SR configuration for power efficiency, the UE 115 may waste PUCCH resources, which may result in increased latency and decreased throughput.

The wireless communications system 100 may support joint adaptation between control channels and other configurations, such as SR configurations, which may enable a UE 115 to apply parameters to SSSGs to increase reliability or power savings for different configurations. In some examples, the UE 115 may receive an indication of a set of multiple SSSGs, where each SSSG may be associated with (e.g., mapped to) a respective parameter set of a configuration of the UE. A parameter set may include power saving parameters, reliability parameters, or a combination thereof. The UE 115 may receive control signaling from a network entity 105 (e.g., DCI) indicating a switch from a first SSSG to a second SSSG. The UE 115 may switch from using the first SSSG to using the second SSSG, and the UE 115 may apply a parameter set to the second SSSG based on the control signaling, where the second SSSG may be associated with the first parameter set. As such, based on a mapping between SSSGs and parameter sets, the UE 115 may utilize particular parameter sets for different SSSGs, which may result in reliability and power saving improvements, among other performance benefits.

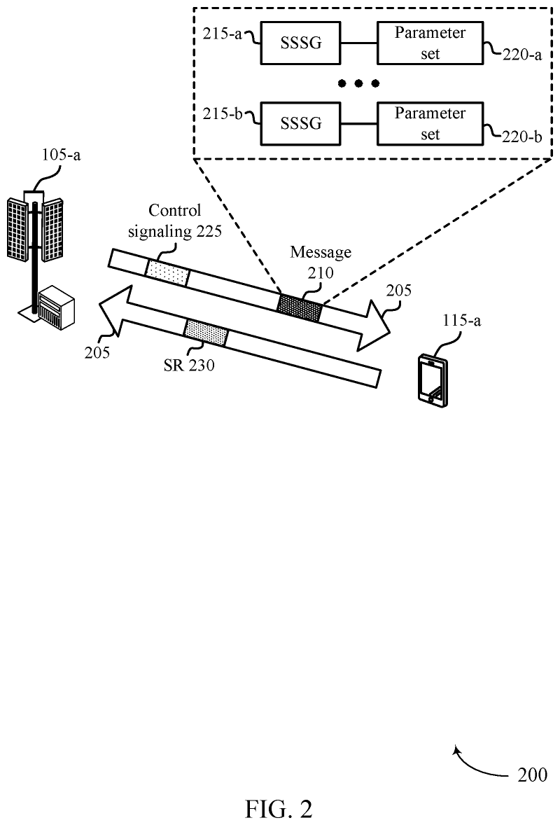

FIG. 2 illustrates an example of a wireless communications system 200 that supports joint adaptation between control channels and other configurations in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a network entity 105-a, which may be examples of corresponding devices described herein. In some examples, the UE 115-a may monitor one or more SSSGs 215 for downlink transmissions (e.g., PDCCHs) from the network entity 105-a.

The wireless communications system 200 may support communications between the network entity 105-a and the UE 115-a. For example, the network entity 105-a may communicate signals (e.g., uplink and downlink transmissions) with the UE 115-a over respective communication links 205, which may be examples of communication links 125 described with reference to FIG. 1. In some examples, the network entity 105-a may transmit a downlink control channel to the UE 115-a via a communication link 205 (e.g., a downlink), and the UE 115-a may transmit an uplink control channel, an SR, or other signaling to the network entity 105-a via a communication link 205 (e.g., an uplink).

To support the adaptation of different configurations (e.g., control channel configurations, SR configurations, and the like), the UE 115-a may receive a message 210 from the network entity 105-a via a communication link 205. The message 210 may indicate a set of multiple SSSGs, where an SSSG 215 may be associated with (e.g., mapped to) a parameter set 220 of a set of multiple configurations of the UE 115-a. For example, the message 210 may indicate an SSSG 215-a that is associated with a parameter set 220-a of a first configuration, and an SSSG 215-b is associated with a parameter set 220-b of a second configuration, among any other quantity of mapped SSSGs 215 and parameter sets 220. In addition, an SSSG 215 may include one or more search space sets. In some cases, the configurations of the UE 115-a may include SR configurations, feedback configurations, or any other signaling configuration the UE 115-a may use, which may be associated with respective parameter sets.

In some examples, the UE 115-a may use an SSSG 215 to monitor for downlink channel transmissions (e.g., PDCCHs) from the network entity 105-a. The network entity 105-a may configure the SSSGs 215 for different purposes. That is, the network entity 105-a may configure the SSSGs 215 using a parameter set 220 that is associated with some performance objective. For example, the set of multiple parameter sets may include power saving parameter sets including one or more power saving parameters, reliability parameter sets including one or more reliability parameters, or both.

In the example of FIG. 2, the parameter set 220-a may be a power saving parameter set including a discontinuous reception (DRX) timer parameter (e.g., indicating a length of a DRX inactivity timer), a downlink offset parameter (e.g., indicating a minimum K0 value for a PDSCH), an uplink offset parameter (e.g., indicating a minimum K2 value for a PUCCH), an antenna parameter (e.g., indicating a maximum quantity of downlink antennas), or any combination thereof. In addition, the parameter set 220-a may include any other power saving parameters the UE 115-a may apply to the configuration of the SSSG 215-a. The network entity 105-a may map the parameter set 220-a to the SSSG 215-a, and as such, the SSSG 215-a may be a power-saving SSSG. In some examples, the network entity 105-a may configure multiple power-saving configuration profiles, where each configuration profile may be a combination of selected power-saving configurations (e.g., one particular value of a minimum K0 value and one particular maximum quantity of downlink antennas) that is included in a given parameter set 220 and mapped to an SSSG 215.

Additionally, the parameter set 220-b may be a reliability parameter set including a repetition parameter (e.g., indicating a maximum repetition quantity for PDSCH and physical uplink shared channel (PUSCH) transmissions), a reference signal parameter (e.g., indicating to use synchronization signal blocks (SSBs) instead of channel state information reference signals (CSI-RSs) for high reliability), a transmission configuration indicator (TCI) parameter (e.g., indicating to use a TCI state associated with wide-coverage reference signals instead of narrow, high-throughput reference signals for high reliability), or any combination thereof. In addition, the parameter set 220-b may include any other reliability parameters that the UE 115-a may apply to the configuration of the SSSG 215-b. The network entity 105-a may map the parameter set 220-b to the SSSG 215-b, and as such, the SSSG 215-b may be a reliability SSSG. In some examples, the network entity 105-a may configure multiple reliability configuration profiles, where each configuration profile may be a combination of selected reliability configurations that is included in a given parameter set 220 and mapped to an SSSG 215.

In some examples, the UE 115-a may receive control signaling 225 from the network entity 105-a indicating to switch from the SSSG 215-a (e.g., a first SSSG) to the SSSG 215-b (e.g., a second SSSG). The UE 115-a may perform the switch from the SSSG 215-a to the SSSG 215-b and apply the parameter set 220-b to the SSSG 215-b based on the control signaling 225 and the mapping between the SSSG 215-b and the parameter set 220-b. That is, after the network entity 105-a transmits the control signaling 225 to switch the active SSSG of the UE 115-a (e.g., the SSSG 215-a the UE 115-a is currently using), the UE 115-a may autonomously apply a parameter set 220 (e.g., power-saving or reliability) associated with the active SSSG.

In some examples, the network entity 105-a may transmit the control signaling 225 and the UE 115-a may perform the switch based on some performance objective. For example, the UE 115-a may use a high-throughput SSSG when the UE 115-a is expected to receive a data burst, and the UE 115-a may switch to a more power-efficient SSSG when signaling traffic becomes sparse. That is, the UE 115-a may receive the control signaling 225 indicating the switch from the SSSG 215-a to the SSSG 215-b based on a change (e.g., a decrease) in signaling traffic. If the SSSG 215-a and the parameter set 220-a are associated with high throughput and the SSSG 215-b and the parameter set 220-b are associated with power savings, the UE 115-a may switch to the SSSG 215-b and apply the parameter set 220-b to the SSSG 215-b to increase power savings.

Alternatively, the UE 115-a may use a high-reliability SSSG when a channel quality is poor (e.g., when the UE 115-a experiences deep fading), and the UE 115-a may switch to a high-throughput SSSG when the channel quality improves. That is, the UE 115-a may receive the control signaling 225 indicating the switch from the SSSG 215-a to the SSSG 215-b based on a change (e.g., an increase) in channel quality. If the SSSG 215-a and the parameter set 220-a are associated with high reliability and the SSSG 215-b and the parameter set 220-b are associated with high throughput, the UE 115-a may switch to the SSSG 215-b and apply the parameter set 220-b to the SSSG 215-b to increase reliability.

In some cases, the SSSGs 215 may be general SSSGs (e.g., not associated with a performance objective such as power savings or reliability). For example, the SSSG 215-a may be referred to as an SSSG #1 or an SSSG A, and the SSSG 215-b may be referred to as an SSSG #2 or an SSSG B. In some examples, the message 210 may include a downlink control channel information element that may include a search space information element. A given search space information element may indicate an SSSG information element, which may indicate individual search spaces. In addition, the message 210 may indicate an information element that lists possible configuration values of the mapped SSSGs 215 and parameter sets 220. For example, a given SSSG information element may indicate some quantity of configured search spaces and associated SR configurations, where the SR configurations may be included in an SR configuration group (SRCG). That is, the SSSG information element may indicate a search space #1 mapped to an SR configuration #1, a search space #2 mapped to an SR configuration #2, and so on, where the search space #1 and the search space #2 are included in an SSSG, where the SR configuration #1 and the SR configuration #2 are included in the SRCG, and where the SSSG and the SRCG are mapped to (e.g., associated with) each other.

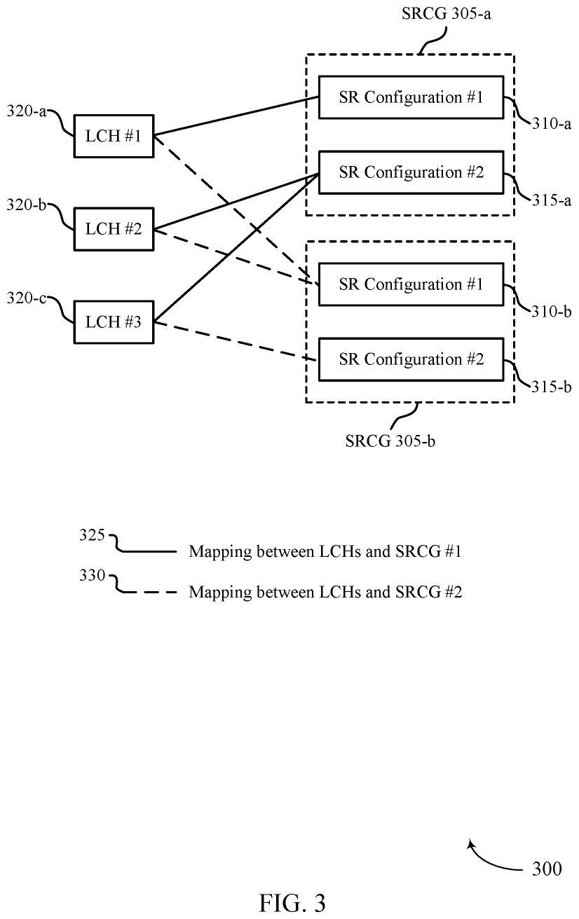

In some cases, the network entity 105-a and the UE 115-a may use the mapping between the SSSGs 215 and the parameter sets 220 as described herein to improve SR configurations. For example, the network entity 105-a may map multiple SRCGs to multiple SSSGs 215 to provide for joint adaptation between PUCCHs and PDCCHs in an SR scenario, which may increase resource utilization and decrease latency. In some examples, using a mapping between SRCGs and the SSSGs 215, the UE 115-a may transmit an SR 230 to the network entity 105-a with higher throughput or power savings. The joint adaptation between a PDCCH and an SR configuration is described herein with reference to FIG. 3.

FIG. 3 illustrates an example of a mapping scheme 300 that supports joint adaptation between control channels and other configurations in accordance with one or more aspects of the present disclosure. In some examples, the mapping scheme 300 may implement aspects of the wireless communications system 100 or may be implemented by aspects of the wireless communications system 100. For example, a UE and a network entity, which may be examples of a UE 115 and a network entity 105 described herein, may use the mapping scheme 300 to provide for joint adaptation between a PDCCH and SR configuration (including a PUCCH), which may decrease latency and improve resource utilization efficiency, among other examples.

A UE and a network entity may use joint adaptation between a control channel and some configuration to reach a performance objective. For example, the joint adaptation may be between a PUCCH and a PDCCH configuration, which the UE and the network entity may utilize for an SR scenario. In some examples, the network entity may configure multiple SRCGs 305, including an SRCG 305-a and an SRCG 305-b. Each SRCG 305 may include multiple SR configurations within each SRCG 305, which may include SR configurations 310 (e.g., SR Configuration #1), SR configurations 315 (e.g., SR Configuration #2), or both. For example, the SRCG 305-a may include an SR configuration 310-a and an SR configuration 315-a, and the SRCG 305-b may include an SR configuration 310-b and an SR configuration 315-b. In some cases, one SRCG 305 may be active at any point in time.

In some cases, within an SRCG 305, the network entity may configure a mapping (e.g., linkages, associations) between a logical channel (LCH) and an SR. The LCH-to-SR mapping may be the same across all SRCGs 305, or the network entity may configure the LCH-to-SR mapping per SRCG 305. For example, the network entity may map an LCH 320-a (e.g., LCH #1) to the SR configuration 310-a via a link 325, where the link 325 indicates a mapping between an LCH 320 and the SRCG 305-a. In addition, the network entity may map the LCH 320-a to the SR configuration 310-b via a link 330, where the link 325 indicates a mapping between an LCH 320 and the SRCG 305-b. In some cases, the network entity may map an LCH 320-b (e.g., LCH #2) to the SR configuration 315-a via a link 325 and to the SR configuration 310-b via a link 330. Additionally, or alternatively, the network entity may map an LCH 320-c (e.g., LCH #3) to the SR configuration 315-a via a link 325 and to the SR configuration 315-b via a link 330. In this way, the network entity may map the SRCGs 305 to LCHs 320 in different ways.

Additionally, the network entity may configure a mapping (e.g., linkages, associations) between an SRCG 305 and an SSSG. In some cases, one SSSG may be associated with one SRCG 305, and more than one SSSG may be associated with (mapped to) a same SRCG 305. For example, a first SSSG (e.g., the SSSG 215-a described with reference to FIG. 2) may be associated with the SRCG 305-a, and a second SSSG (e.g., the SSSG 215-b described with reference to FIG. 2) may be associated with the SRCG 305-b. Alternatively, the first SSSG and the second SSSG may both be associated with the SRCG 305-a or the SRCG 305-b. In some cases, the mapping between SSSGs and SRCGs 305 may differ for different PUCCH groups. For example, in a carrier aggregation configuration, the UE may use multiple PUCCH groups. That is, the UE may use at least two serving cells, each serving cell configured with PUCCH. Other serving cells may be associated with particular PUCCH secondary cells (SCells). As such, any HARQ feedback or SRs triggered on a particular serving cell may be transmitted on a PUCCH associated with that serving cell.

In some examples, the network entity may transmit a message to the UE indicating the SSSGs that are associated with (mapped to) the respective SRCGs 305. For example, the message may indicate that the first SSSG is mapped to the SRCG 305-a and the second SSSG is mapped to the SRCG 305-b, or message may indicate that two or more SSSGs are associated with the SRCG 305-a or the SRCG 305-b. In some examples, if the message indicates the SSSGs and the SRCGs 305 (e.g., in respective information elements of a system information message), the UE may understand that the mapping between the SSSGs and the SRCGs 305 is enabled. The network entity may transmit DCI to the UE indicating to switch from the first SSSG to the second SSSG. Based on receiving the DCI, the UE may switch to (e.g., activate) the second SSSG, and the UE may switch its active SRCG (e.g., the SRCG 305 the UE is currently using) to the SRCG 305 associated with the newly activated second SSSG. For example, the UE may switch to the second SSSG and apply the SRCG 305-b to the second SSSG if the SRCG 305-b is mapped to the second SSSG. In some examples, the UE may transmit an SR (e.g., an SR 230 described with reference to FIG. 2) via a channel associated with the SR (e.g., an LCH 320) and using an SR configuration 310 or an SR configuration 315, where the SR (e.g., via the SR configuration 310 or the SR configuration 315) and the channel (e.g., the LCH 320) are indicated in an SRCG 305. For example, the UE may transmit an SR using the SR configuration 310-a and the LCH 320-a, which are associated with the SRCG 305-a.

In some examples, as described with reference to FIG. 2, the network entity may configure the SSSGs for high throughput, high reliability, power savings, or other performance targets. For example, if the UE uses an SSSG configured for high throughput, the UE may use an SR configuration 310 or an SR configuration 315 associated with the SSSG with a short periodicity to enable reception of more downlink transmissions. Alternatively, if the UE uses an SSSG configured for power efficiency, the UE may use an SR configuration 310 or an SR configuration 315 associated with the SSSG with a long periodicity to enable the UE to reuse PUCCH resources for SR transmissions, encouraging the network entity to configure short SR periodicities.

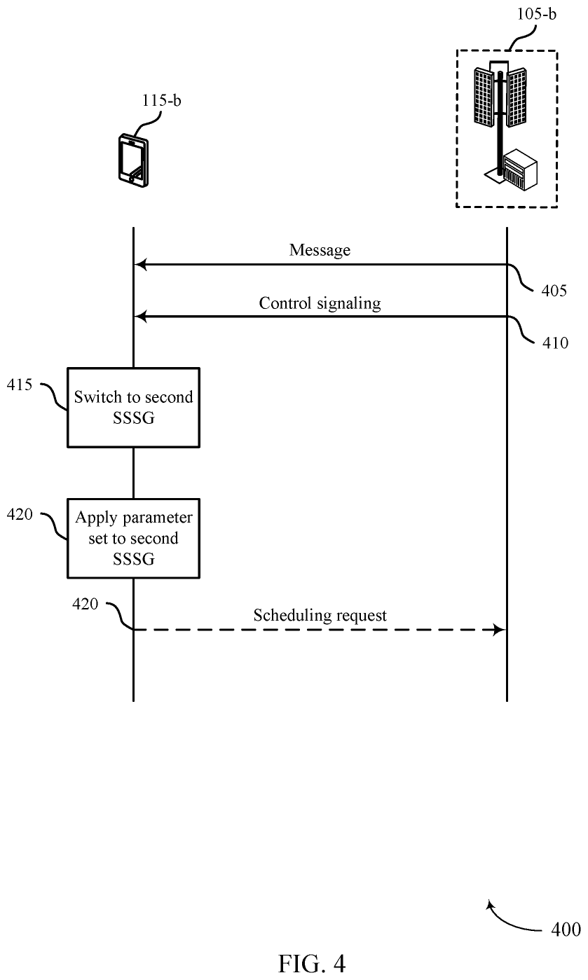

FIG. 4 illustrates an example of a process flow 400 that supports joint adaptation between control channels and other configurations in accordance with one or more aspects of the present disclosure. The process flow 400 may implement aspects of wireless communications systems 100 and 200, or may be implemented by aspects of the wireless communications systems 100 and 200. For example, the process flow 400 may illustrate operations between a UE 115-b and a network entity 105-b, which may be examples of corresponding devices described herein. In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b may receive, from the network entity 105-b, a message indicating a set of multiple SSSGs, wherein respective SSSGs of the set of multiple SSSGs are associated with respective parameter sets of a set of multiple configurations of the UE 115-b. For example, a first SSSG may be associated with (mapped to) a parameter set of a first configuration, and a second SSSG may be associated with (mapped to) a parameter set of a second configuration. In some examples, the parameter sets may be power-saving parameter sets that include one or more power saving parameters, reliability parameter sets that include one or more reliability parameters, or a combination thereof.

At 410, the UE 115-b may receive, from the network entity 105-b, control signaling indicating a switch from a first SSSG of the set of multiple SSSGs to a second SSSG of the set of multiple SSSGs. In some examples, the control signaling may include DCI or some other dynamic signaling. In some examples, the network entity 105-b may transmit the control signaling based on a change (e.g., a decrease) in traffic, and a change (e.g., an increase) in a channel quality, or some other scenario in which the UE 115-b may benefit from using a particular SSSG (e.g., for reliability or power savings).

At 415, the UE 115-b may switch from the first SSSG to the second SSSG based on receiving the control signaling. For example, the UE may initially use the first SSSG, which may be configured for high throughput, to receive a data burst. If the UE experiences a decrease in traffic, then the UE may switch to the second SSSG, which may be configured for power savings, such that the UE may enter a low power mode until the traffic increases again.

At 420, the UE 115-b may apply a parameter set of the set of multiple configurations of the UE to the second SSSG based on the control signaling, where the second SSSG may be associated with the parameter set. That is, because of the mapping between the SSSGs and the parameter sets, the UE may apply an associated parameter set to the active SSSG the UE is using. For example, if the UE switches to the second SSSG to save power, the UE may apply the parameter set to the second SSSG, which may include power saving parameters. Accordingly, the second SSSG may be a power-saving SSSG.

At 425, if the parameter sets include SRCGs (such that respective SSSGs are mapped to respective SRCGs), the UE 115-a may transmit, to the network entity 105-a, an SR via a channel that is associated with the SR, where the network entity 105-b may indicate the SR and the channel in a respective SRCG. Put another way, the network entity 105-b may map a particular channel (e.g., a logical channel) to one or more SR configurations, and thus, one or more SRCGs. The SRCGs may then be mapped to an SSSG, and the UE may transmit SRs according to the association between SRCGs and SSSGs.

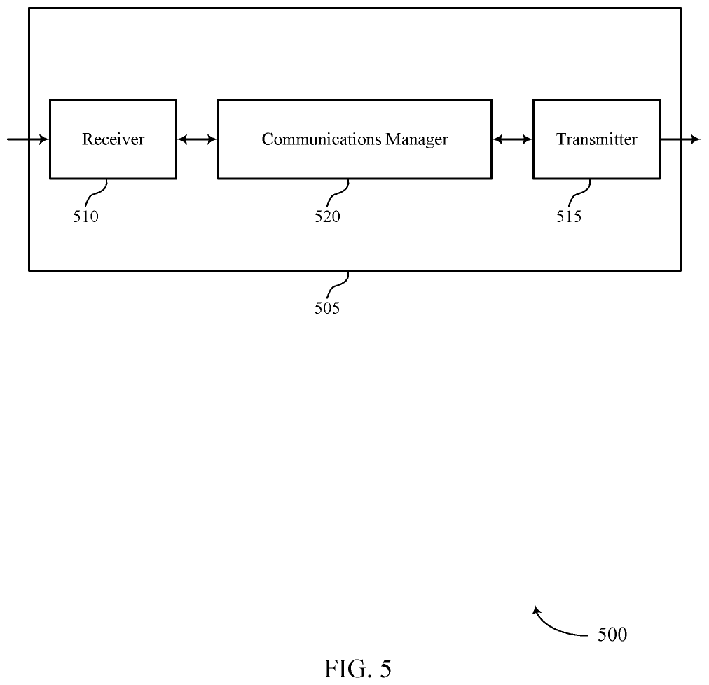

FIG. 5 shows a block diagram 500 of a device 505 that supports joint adaptation between control channels and other configurations in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to joint adaptation between control channels and other configurations). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to joint adaptation between control channels and other configurations). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of joint adaptation between control channels and other configurations as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving a message indicating a set of multiple SSSGs, where respective SSSGs of the set of multiple SSSGs are associated with respective parameter sets of a set of multiple configuration of the UE. The communications manager 520 may be configured as or otherwise support a means for receiving control signaling indicating a switch from a first SSSG of the set of multiple SSSGs to a second SSSG of the set of multiple SSSGs. The communications manager 520 may be configured as or otherwise support a means for applying a parameter set of a first configuration of the set of multiple configurations of the UE to the second SSSG based on the control signaling, where the second SSSG is associated with the first configuration.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for applying a parameter set to an SSSG for some performance targets, which may provide for increased power savings, reduced processing, more efficient utilization of communication resources, and higher signaling throughput.

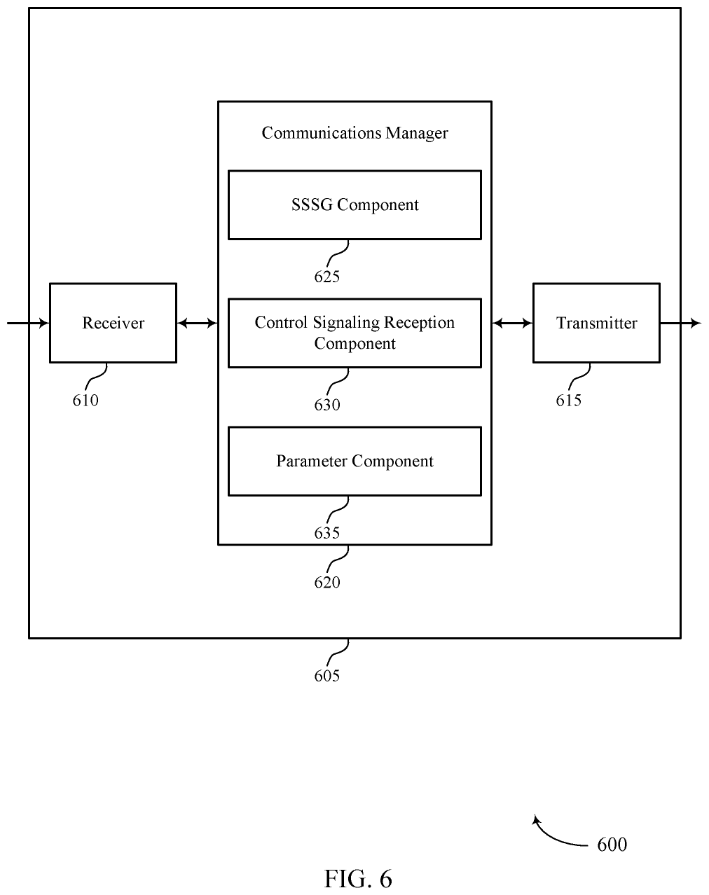

FIG. 6 shows a block diagram 600 of a device 605 that supports joint adaptation between control channels and other configurations in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to joint adaptation between control channels and other configurations). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to joint adaptation between control channels and other configurations). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of joint adaptation between control channels and other configurations as described herein. For example, the communications manager 620 may include an SSSG component 625, a control signaling reception component 630, a parameter component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The SSSG component 625 may be configured as or otherwise support a means for receiving a message indicating a set of multiple SSSGs, where respective SSSGs of the set of multiple SSSGs are associated with respective parameter sets of a set of multiple configurations of the UE. The control signaling reception component 630 may be configured as or otherwise support a means for receiving control signaling indicating a switch from a first SSSG of the set of multiple SSSGs to a second SSSG of the set of multiple SSSGs. The parameter component 635 may be configured as or otherwise support a means for applying a parameter set of a first configuration of the set of multiple configurations of the UE to the second SSSG based on the control signaling, where the second SSSG is associated with the first configuration.

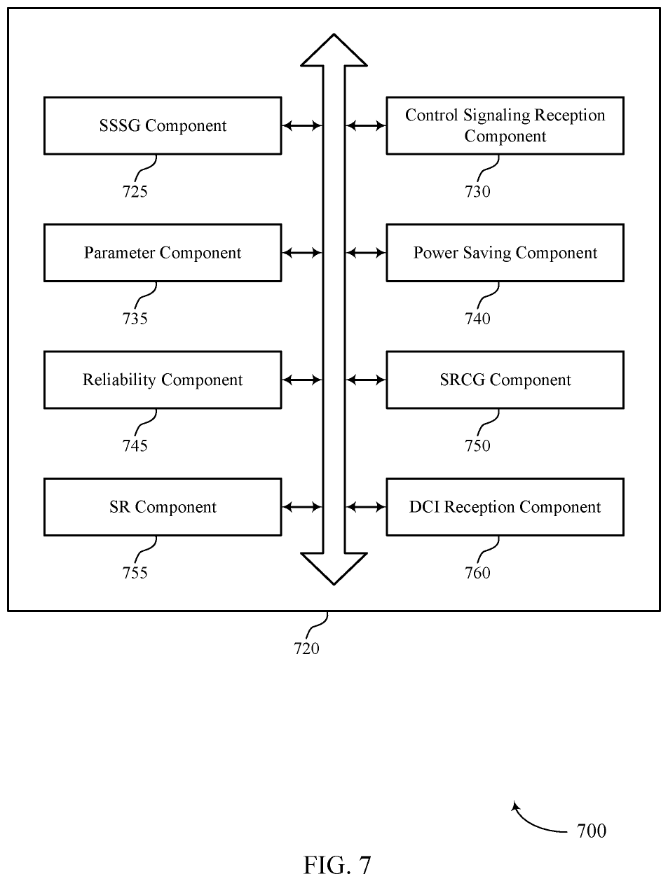

FIG. 7 shows a block diagram 700 of a communications manager 720 that supports joint adaptation between control channels and other configurations in accordance with one or more aspects of the present disclosure. The communications manager 720 may be an example of aspects of a communications manager 520, a communications manager 620, or both, as described herein. The communications manager 720, or various components thereof, may be an example of means for performing various aspects of joint adaptation between control channels and other configurations as described herein. For example, the communications manager 720 may include an SSSG component 725, a control signaling reception component 730, a parameter component 735, a power saving component 740, a reliability component 745, an SRCG component 750, an SR component 755, a DCI reception component 760, or any combination thereof. Each of these components may communicate, directly or indirectly, with one another (e.g., via one or more buses).

The communications manager 720 may support wireless communication at a UE in accordance with examples as disclosed herein. The SSSG component 725 may be configured as or otherwise support a means for receiving a message indicating a set of multiple SSSGs, where respective SSSGs of the set of multiple SSSGs are associated with respective parameter sets of a set of multiple configurations of the UE. The control signaling reception component 730 may be configured as or otherwise support a means for receiving control signaling indicating a switch from a first SSSG of the set of multiple SSSGs to a second SSSG of the set of multiple SSSGs. The parameter component 735 may be configured as or otherwise support a means for applying a parameter set of a first configuration of the set of multiple configurations of the UE to the second SSSG based on the control signaling, where the second SSSG is associated with the first configuration.

In some examples, to support receiving the message, the SSSG component 725 may be configured as or otherwise support a means for receiving the message indicating the set of multiple SSSGs and indicating the set of multiple configurations, where the set of multiple configurations includes a set of multiple power saving parameter sets, a set of multiple reliability parameter sets, or any combination thereof, and where the respective SSSGs are associated with a respective power saving parameter set or a respective reliability parameter set.

In some examples, to support receiving the message, the power saving component 740 may be configured as or otherwise support a means for receiving the message indicating the set of multiple configurations, where a power saving parameter set of the set of multiple configurations includes a DRX timer parameter, a downlink offset parameter, an uplink offset parameter, an antenna parameter, or any combination thereof.

In some examples, to support receiving the message, the reliability component 745 may be configured as or otherwise support a means for receiving the message indicating the set of multiple configurations, where a reliability parameter set of the set of multiple configurations includes a repetition parameter, a reference signal parameter, a TCI parameter, or any combination thereof.

In some examples, the control signaling reception component 730 may be configured as or otherwise support a means for receiving the control signaling indicating the switch from the first SSSG to the second SSSG based on a change in traffic. In some examples, the parameter component 735 may be configured as or otherwise support a means for applying the parameter set to the second SSSG based on the control signaling, where the second SSSG is associated with the first configuration, and where the parameter set includes a power saving parameter set.

In some examples, the control signaling reception component 730 may be configured as or otherwise support a means for receiving the control signaling indicating the switch from the first SSSG to the second SSSG based on a change in channel quality. In some examples, the parameter component 735 may be configured as or otherwise support a means for applying the parameter set to the second SSSG based on the control signaling, where the second SSSG is associated with the first configuration, and where the parameter set includes a reliability parameter set.

In some examples, to support receiving the message, the SRCG component 750 may be configured as or otherwise support a means for receiving the message indicating the set of multiple SSSGs, where the respective SSSGs are associated with respective SRCGs of a set of multiple SRCGs.

In some examples, the DCI reception component 760 may be configured as or otherwise support a means for receiving DCI indicating the switch from the first SSSG to the second SSSG. In some examples, the SRCG component 750 may be configured as or otherwise support a means for applying a first SRCG to the second SSSG based on the control signaling, where the second SSSG is associated with the first SRCG.

In some examples, to support receiving the message, the SRCG component 750 may be configured as or otherwise support a means for receiving the message indicating the set of multiple SSSGs, where two or more SSSGs are associated with a respective SRCG.

In some examples, the SR component 755 may be configured as or otherwise support a means for transmitting a SR via a channel associated with the SR, where the SR and the channel are indicated in a respective SRCG.

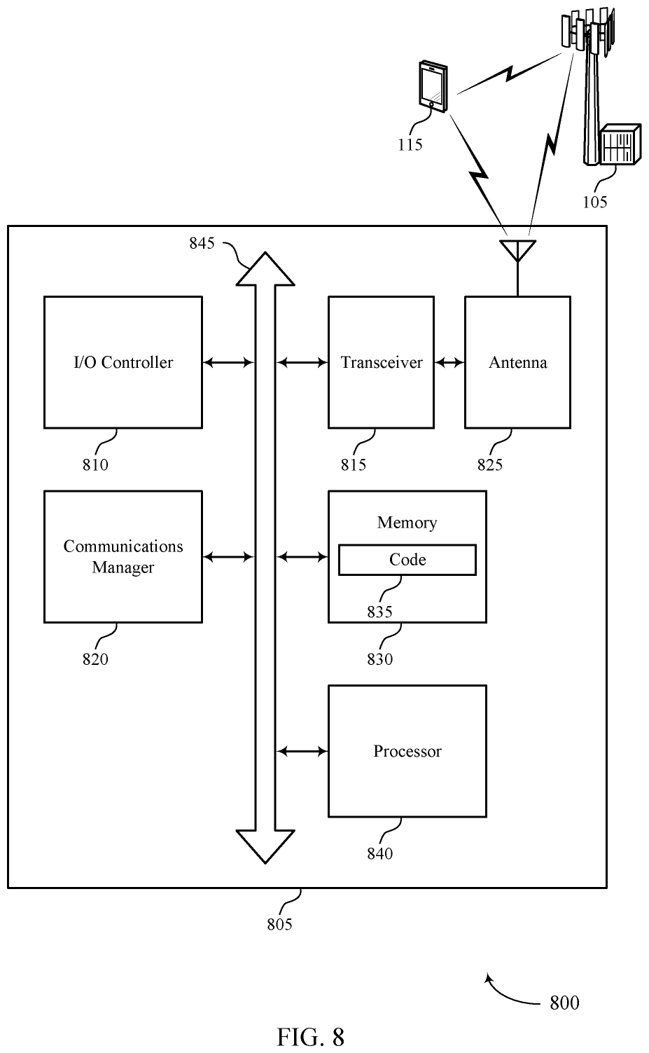

FIG. 8 shows a diagram of a system 800 including a device 805 that supports joint adaptation between control channels and other configurations in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting joint adaptation between control channels and other configurations). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving a message indicating a set of multiple SSSGs, where respective SSSGs of the set of multiple SSSGs are associated with respective parameter sets of a set of multiple configurations of the UE. The communications manager 820 may be configured as or otherwise support a means for receiving control signaling indicating a switch from a first SSSG of the set of multiple SSSGs to a second SSSG of the set of multiple SSSGs. The communications manager 820 may be configured as or otherwise support a means for applying a parameter set of configurations of a UE to the second SSSG based on the control signaling, where the second SSSG is associated with the first configuration.

By including or configuring the communications manager 820 in accordance with examples as described herein, the device 805 may support techniques for applying a parameter set to an SSSG for some performance targets, which may provide for increased power savings, reduced processing, more efficient utilization of communication resources, and higher signaling throughput.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of joint adaptation between control channels and other configurations as described herein, or the processor 840 and the memory 830 may be otherwise configured to perform or support such operations.

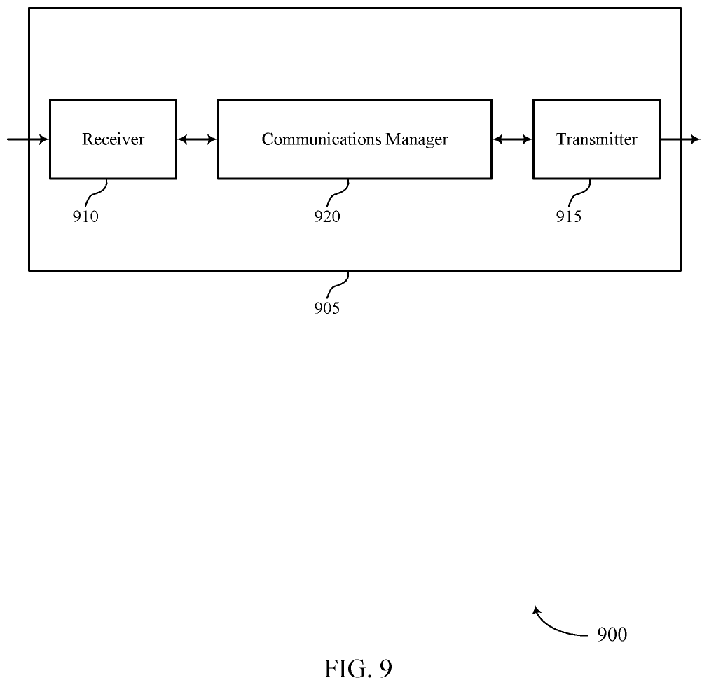

FIG. 9 shows a block diagram 900 of a device 905 that supports joint adaptation between control channels and other configurations in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of joint adaptation between control channels and other configurations as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting a message indicating a set of multiple SSSGs, where respective SSSGs of the set of multiple SSSGs are associated with respective parameter sets of a set of multiple configurations of the UE. The communications manager 920 may be configured as or otherwise support a means for transmitting control signaling indicating a switch from a first SSSG of the set of multiple SSSGs to a second SSSG of the set of multiple SSSGs.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for applying a parameter set to an SSSG for some performance targets, which may provide for increased power savings, reduced processing, more efficient utilization of communication resources, and higher signaling throughput.

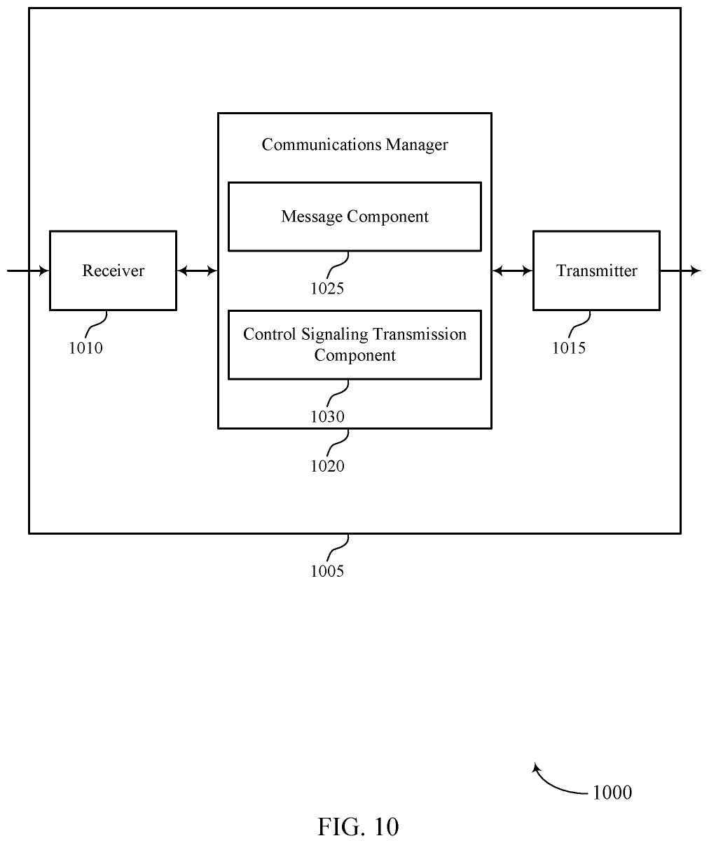

FIG. 10 shows a block diagram 1000 of a device 1005 that supports joint adaptation between control channels and other configurations in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of joint adaptation between control channels and other configurations as described herein. For example, the communications manager 1020 may include a message component 1025 a control signaling transmission component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The message component 1025 may be configured as or otherwise support a means for transmitting a message indicating a set of multiple SSSGs, where respective SSSGs of the set of multiple SSSGs are associated with respective parameter sets of a set of multiple configurations of the UE. The control signaling transmission component 1030 may be configured as or otherwise support a means for transmitting control signaling indicating a switch from a first SSSG of the set of multiple SSSGs to a second SSSG of the set of multiple SSSGs.

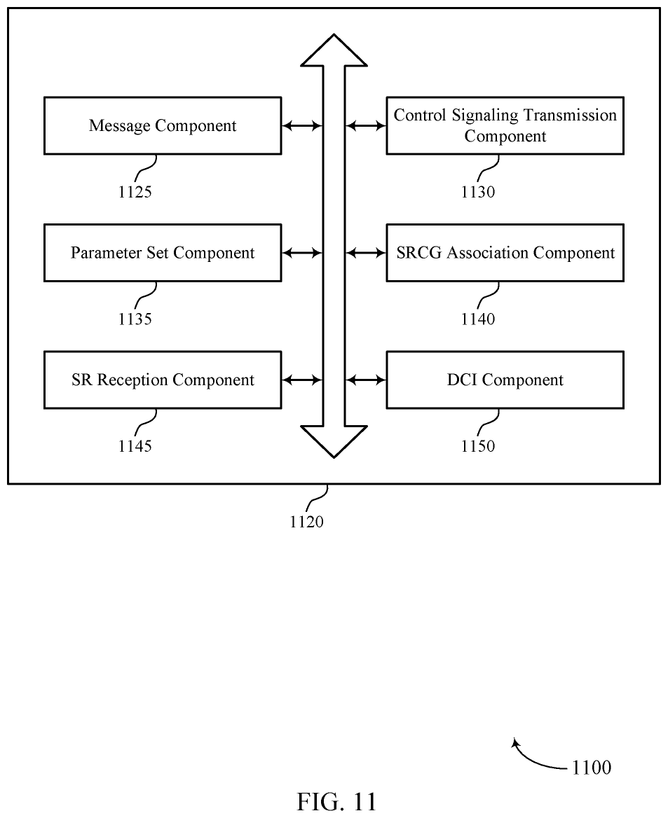

FIG. 11 shows a block diagram 1100 of a communications manager 1120 that supports joint adaptation between control channels and other configurations in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of joint adaptation between control channels and other configurations as described herein. For example, the communications manager 1120 may include a message component 1125, a control signaling transmission component 1130, a parameter set component 1135, an SRCG association component 1140, an SR reception component 1145, a DCI component 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The message component 1125 may be configured as or otherwise support a means for transmitting a message indicating a set of multiple SSSGs, where respective SSSGs of the set of multiple SSSGs are associated with respective parameter sets of a set of multiple configurations of the UE. The control signaling transmission component 1130 may be configured as or otherwise support a means for transmitting control signaling indicating a switch from a first SSSG of the set of multiple SSSGs to a second SSSG of the set of multiple SSSGs.

In some examples, to support transmitting the message, the parameter set component 1135 may be configured as or otherwise support a means for transmitting the message indicating the set of multiple SSSGs and indicating the set of multiple configurations, where the set of multiple configurations includes a set of multiple power saving parameter sets, a set of multiple reliability parameter sets, or any combination thereof, and where the respective SSSGs are associated with a respective power saving parameter set or a respective reliability parameter set.

In some examples, to support transmitting the message, the parameter set component 1135 may be configured as or otherwise support a means for transmitting the message indicating the set of multiple configurations, where a power saving parameter set of the set of multiple configurations includes a DRX timer parameter, a downlink offset parameter, an uplink offset parameter, an antenna parameter, or any combination thereof.

In some examples, to support transmitting the message, the parameter set component 1135 may be configured as or otherwise support a means for transmitting the message indicating the set of multiple configurations, where a power saving parameter set of the set of multiple configurations includes a repetition parameter, a reference signal parameter, a TCI parameter, or any combination thereof.

In some examples, to support transmitting the control signaling, the control signaling transmission component 1130 may be configured as or otherwise support a means for transmitting the control signaling indicating the switch from the first SSSG to the second SSSG based on a change in traffic.

In some examples, to support transmitting the control signaling, the control signaling transmission component 1130 may be configured as or otherwise support a means for transmitting the control signaling indicating the switch from the first SSSG to the second SSSG based on a change in channel quality.

In some examples, to support transmitting the message, the SRCG association component 1140 may be configured as or otherwise support a means for transmitting the message indicating the set of multiple SSSGs, where the respective SSSGs are associated with respective SRCGs of a set of multiple SRCGs.

In some examples, the DCI component 1150 may be configured as or otherwise support a means for transmitting DCI indicating the switch from the first SSSG to the second SSSG.

In some examples, to support transmitting the message, the SRCG association component 1140 may be configured as or otherwise support a means for transmitting the message indicating the set of multiple SSSGs, where two or more SSSGs are associated with a respective SRCG.

In some examples, the SR reception component 1145 may be configured as or otherwise support a means for receiving a SR via a channel associated with the SR, where the SR and the channel are indicated in a respective SRCG.

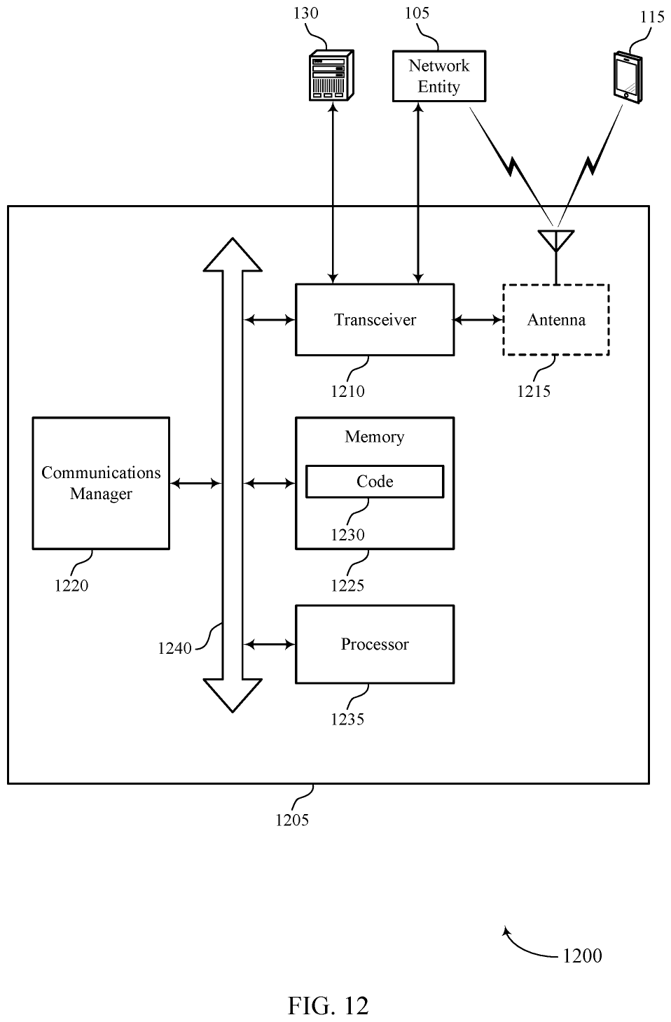

FIG. 12 shows a diagram of a system 1200 including a device 1205 that supports joint adaptation between control channels and other configurations in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting joint adaptation between control channels and other configurations). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205.

The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting a message indicating a set of multiple SSSGs, where respective SSSGs of the set of multiple SSSGs are associated with respective parameter sets of a set of multiple configurations of the UE. The communications manager 1220 may be configured as or otherwise support a means for transmitting control signaling indicating a switch from a first SSSG of the set of multiple SSSGs to a second SSSG of the set of multiple SSSGs.

By including or configuring the communications manager 1220 in accordance with examples as described herein, the device 1205 may support techniques for applying a parameter set to an SSSG for some performance targets, which may provide for increased power savings, reduced processing, more efficient utilization of communication resources, and higher signaling throughput.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of joint adaptation between control channels and other configurations as described herein, or the processor 1235 and the memory 1225 may be otherwise configured to perform or support such operations.

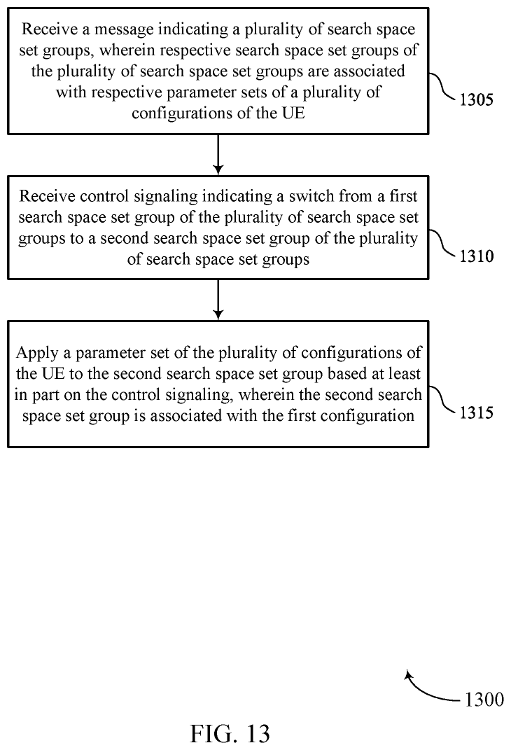

FIG. 13 shows a flowchart illustrating a method 1300 that supports joint adaptation between control channels and other configurations in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a message indicating a set of multiple SSSGs, where respective SSSGs of the set of multiple SSSGs are associated with respective parameter sets of a set of multiple configurations the UE. The operations of 1305 may be performed in accordance with examples as disclosed herein. In some examples, aspects of the operations of 1305 may be performed by an SSSG component 725 as described with reference to FIG. 7.

At 1310, the method may include receiving control signaling indicating a switch from a first SSSG of the set of multiple SSSGs to a second SSSG of the set of multiple SSSGs. The operations of 1310 may be performed in accordance with examples as disclosed herein. In some examples, aspects of the operations of 1310 may be performed by a control signaling reception component 730 as described with reference to FIG. 7.

At 1315, the method may include applying a parameter set of the set of multiple configurations of the UE to the second SSSG based on the control signaling, where the second SSSG is associated with the first configuration. The operations of 1315 may be performed in accordance with examples as disclosed herein. In some examples, aspects of the operations of 1315 may be performed by a parameter component 735 as described with reference to FIG. 7.

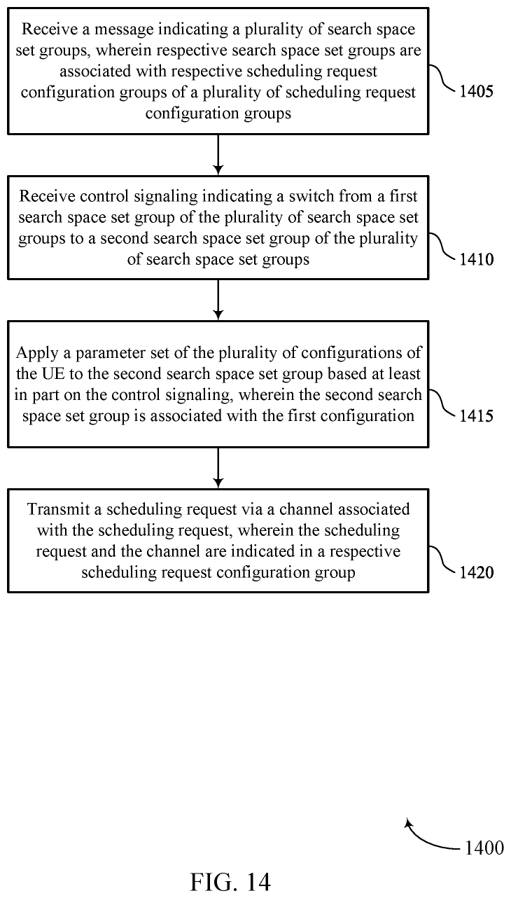

FIG. 14 shows a flowchart illustrating a method 1400 that supports joint adaptation between control channels and other configurations in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a message indicating a set of multiple SSSGs, where respective SSSGs are associated with respective SRCGs of a set of multiple SRCGs. The operations of 1405 may be performed in accordance with examples as disclosed herein. In some examples, aspects of the operations of 1405 may be performed by an SRCG component 750 as described with reference to FIG. 7.

At 1410, the method may include receiving control signaling indicating a switch from a first SSSG of the set of multiple SSSGs to a second SSSG of the set of multiple SSSGs. The operations of 1410 may be performed in accordance with examples as disclosed herein. In some examples, aspects of the operations of 1410 may be performed by a control signaling reception component 730 as described with reference to FIG. 7.

At 1415, the method may include applying a parameter set of the set of multiple configurations of the UE to the second SSSG based on the control signaling, where the second SSSG is associated with the first configuration. The operations of 1415 may be performed in accordance with examples as disclosed herein. In some examples, aspects of the operations of 1415 may be performed by a parameter component 735 as described with reference to FIG. 7.

At 1420, the method may include transmitting a SR via a channel associated with the SR, where the SR and the channel are indicated in a respective SRCG. The operations of 1420 may be performed in accordance with examples as disclosed herein. In some examples, aspects of the operations of 1420 may be performed by an SR component 755 as described with reference to FIG. 7.

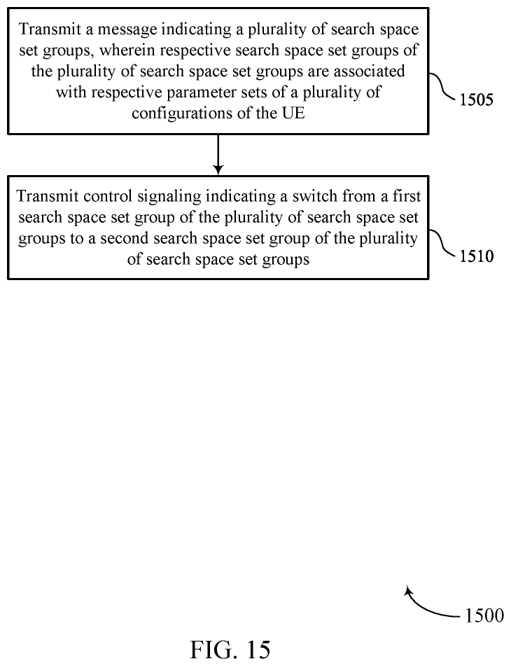

FIG. 15 shows a flowchart illustrating a method 1500 that supports joint adaptation between control channels and other configurations in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a message indicating a set of multiple SSSGs, where respective SSSGs of the set of multiple SSSGs are associated with respective parameter sets of a set of multiple configurations of the UE. The operations of 1505 may be performed in accordance with examples as disclosed herein. In some examples, aspects of the operations of 1505 may be performed by a message component 1125 as described with reference to FIG. 11.

At 1510, the method may include transmitting control signaling indicating a switch from a first SSSG of the set of multiple SSSGs to a second SSSG of the set of multiple SSSGs. The operations of 1510 may be performed in accordance with examples as disclosed herein. In some examples, aspects of the operations of 1510 may be performed by a control signaling transmission component 1130 as described with reference to FIG. 11.

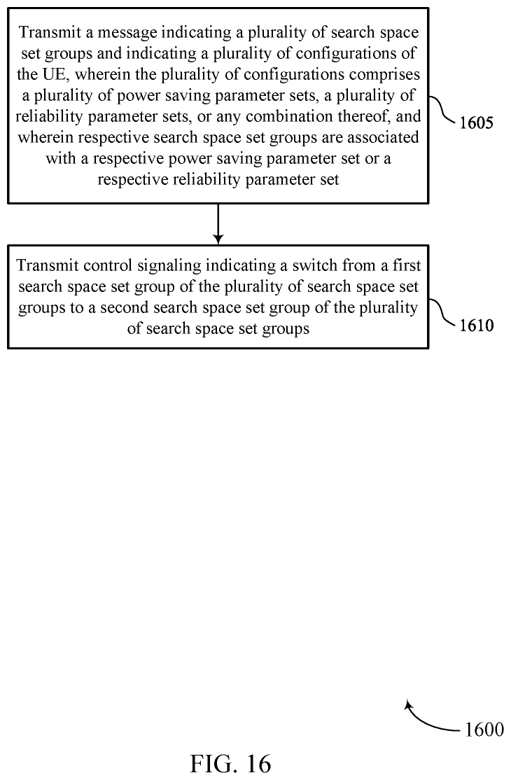

FIG. 16 shows a flowchart illustrating a method 1600 that supports joint adaptation between control channels and other configurations in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a message indicating a set of multiple SSSGs and indicating a set of multiple configurations of a UE, where the set of multiple configurations includes a set of multiple power saving parameter sets, a set of multiple reliability parameter sets, or any combination thereof, and where respective SSSGs are associated with a respective power saving parameter set or a respective reliability parameter set. The operations of 1605 may be performed in accordance with examples as disclosed herein. In some examples, aspects of the operations of 1605 may be performed by a parameter set component 1135 as described with reference to FIG. 11.

At 1610, the method may include transmitting control signaling indicating a switch from a first SSSG of the set of multiple SSSGs to a second SSSG of the set of multiple SSSGs. The operations of 1610 may be performed in accordance with examples as disclosed herein. In some examples, aspects of the operations of 1610 may be performed by a control signaling transmission component 1130 as described with reference to FIG. 11.

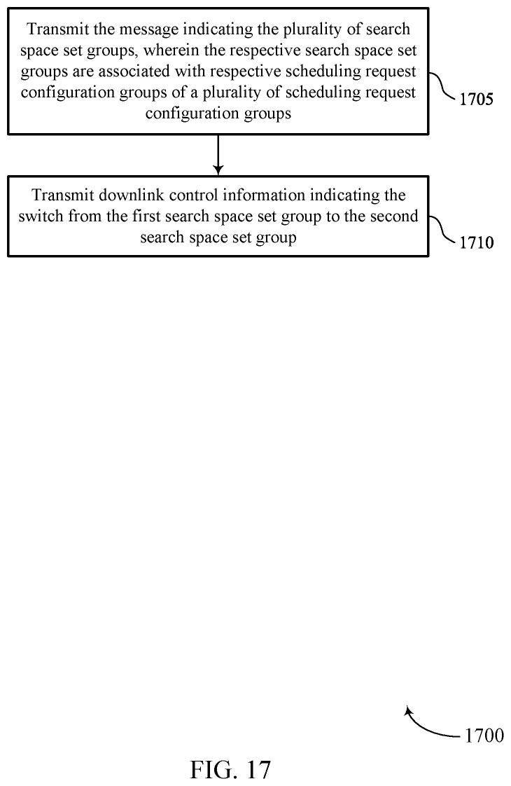

FIG. 17 shows a flowchart illustrating a method 1700 that supports joint adaptation between control channels and other configurations in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a message indicating a set of multiple SSSGs, where respective SSSGs are associated with respective SRCGs of a set of multiple SRCGs. The operations of 1705 may be performed in accordance with examples as disclosed herein. In some examples, aspects of the operations of 1705 may be performed by an SRCG association component 1140 as described with reference to FIG. 11.

At 1710, the method may include transmitting DCI indicating the switch from the first SSSG to the second SSSG. The operations of 1710 may be performed in accordance with examples as disclosed herein. In some examples, aspects of the operations of 1710 may be performed by a DCI component 1150 as described with reference to FIG. 11.

The Following Provides an Overview of Aspects of the Present Disclosure:

Aspect 1: A method for wireless communication at a UE, comprising: receiving a message indicating a plurality of SSSGs, wherein respective SSSGs of the plurality of SSSGs are associated with respective parameter sets of a plurality of configurations of the UE; receiving control signaling indicating a switch from a first SSSG of the plurality of SSSGs to a second SSSG of the plurality of SSSGs; and applying a parameter set of a first configuration of the plurality of configurations of the UE to the second SSSG based at least in part on the control signaling, wherein the second SSSG is associated with the first configuration.

Aspect 2: The method of aspect 1, wherein receiving the message comprises: receiving the message indicating the plurality of SSSGs and indicating the plurality of configurations, wherein the plurality of configurations comprises a plurality of power saving parameter sets, a plurality of reliability parameter sets, or any combination thereof, and wherein the respective SSSGs are associated with a respective power saving parameter set or a respective reliability parameter set.

Aspect 3: The method of any of aspects 1 through 2, wherein receiving the message comprises: receiving the message indicating the plurality of configurations, wherein a power saving parameter set of the plurality of configurations comprises a DRX timer parameter, a downlink offset parameter, an uplink offset parameter, an antenna parameter, or any combination thereof.

Aspect 4: The method of any of aspects 1 through 3, wherein receiving the message comprises: receiving the message indicating the plurality of configurations, wherein a reliability parameter set of the plurality of configurations comprises a repetition parameter, a reference signal parameter, a TCI parameter, or any combination thereof.

Aspect 5: The method of any of aspects 1 through 4, further comprising: receiving the control signaling indicating the switch from the first SSSG to the second SSSG based at least in part on a change in traffic; and applying the parameter set to the second SSSG based at least in part on the control signaling, wherein the second SSSG is associated with the first configuration, and wherein the parameter set comprises a power saving parameter set.

Aspect 6: The method of any of aspects 1 through 5, further comprising: receiving the control signaling indicating the switch from the first SSSG to the second SSSG based at least in part on a change in channel quality; and applying the parameter set to the second SSSG based at least in part on the control signaling, wherein the second SSSG is associated with the first configuration, and wherein the parameter set comprises a reliability parameter set.

Aspect 7: The method of any of aspects 1 through 6, wherein receiving the message comprises: receiving the message indicating the plurality of SSSGs, wherein the respective SSSGs are associated with respective SRCGs of a plurality of SRCGs.

Aspect 8: The method of aspect 7, further comprising: receiving DCI indicating the switch from the first SSSG to the second SSSG; and applying a first SRCG to the second SSSG based at least in part on the control signaling, wherein the second SSSG is associated with the first SRCG.

Aspect 9: The method of any of aspects 7 through 8, wherein receiving the message comprises: receiving the message indicating the plurality of SSSGs, wherein two or more SSSGs are associated with a respective SRCG.

Aspect 10: The method of any of aspects 1 through 9, further comprising: transmitting an SR via a channel associated with the SR, wherein the SR and the channel are indicated in a respective SRCG.

Aspect 11: A method for wireless communication at a network entity, comprising: transmitting a message indicating a plurality of SSSGs, wherein respective SSSGs of the plurality of SSSGs are associated with respective parameter sets of a plurality of configurations of a UE; and transmitting control signaling indicating a switch from a first SSSG of the plurality of SSSGs to a second SSSG of the plurality of SSSGs.

Aspect 12: The method of aspect 11, wherein transmitting the message comprises: transmitting the message indicating the plurality of SSSGs and indicating the plurality of configurations, wherein the plurality of configurations comprises a plurality of power saving parameter sets, a plurality of reliability parameter sets, or any combination thereof, and wherein the respective SSSGs are associated with a respective power saving parameter set or a respective reliability parameter set.

Aspect 13: The method of any of aspects 11 through 12, wherein transmitting the message comprises: transmitting the message indicating the plurality of configurations, wherein a power saving parameter set of the plurality of configurations comprises a DRX timer parameter, a downlink offset parameter, an uplink offset parameter, an antenna parameter, or any combination thereof.

Aspect 14: The method of any of aspects 11 through 13, wherein transmitting the message comprises: transmitting the message indicating the plurality of configurations, wherein a power saving parameter set of the plurality of configurations comprises a repetition parameter, a reference signal parameter, a TCI parameter, or any combination thereof.

Aspect 15: The method of any of aspects 11 through 14, wherein transmitting the control signaling comprises: transmitting the control signaling indicating the switch from the first SSSG to the second SSSG based at least in part on a change in traffic.

Aspect 16: The method of any of aspects 11 through 15, wherein transmitting the control signaling comprises: transmitting the control signaling indicating the switch from the first SSSG to the second SSSG based at least in part on a change in channel quality.

Aspect 17: The method of any of aspects 11 through 16, wherein transmitting the message comprises: transmitting the message indicating the plurality of SSSGs, wherein the respective SSSGs are associated with respective SRCGs of a plurality of SRCGs.

Aspect 18: The method of aspect 17, further comprising: transmitting DCI indicating the switch from the first SSSG to the second SSSG.

Aspect 19: The method of any of aspects 17 through 18, wherein transmitting the message comprises: transmitting the message indicating the plurality of SSSGs, wherein two or more SSSGs are associated with a respective SRCG.

Aspect 20: The method of any of aspects 11 through 19, further comprising: receiving an SR via a channel associated with the SR, wherein the SR and the channel are indicated in a respective SRCG.

Aspect 21: An apparatus for wireless communication at a UE, comprising a processor; memory coupled with the processor; and one or more instructions stored in the memory and executable by the processor to cause the apparatus to, based at least in part on the one or more instructions, perform a method of any of aspects 1 through 10.

Aspect 22: An apparatus for wireless communication at a UE, comprising at least one means for performing a method of any of aspects 1 through 10.

Aspect 23: A non-transitory computer-readable medium storing code for wireless communication at a UE, the code comprising instructions executable by a processor to perform a method of any of aspects 1 through 10.

Aspect 24: An apparatus for wireless communication at a network entity, comprising a processor; memory coupled with the processor; and one or more instructions stored in the memory and executable by the processor to cause the apparatus to, based at least in part on the one or more instructions, perform a method of any of aspects 11 through 20.

Aspect 25: An apparatus for wireless communication at a network entity, comprising at least one means for performing a method of any of aspects 11 through 20.

Aspect 26: A non-transitory computer-readable medium storing code for wireless communication at a network entity, the code comprising instructions executable by a processor to perform a method of any of aspects 11 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
one or more instructions stored in the memory and executable by the processor to cause the apparatus to, based at least in part on the one or more instructions:
receive a message indicating a plurality of search space set groups, wherein respective search space set groups of the plurality of search space set groups are associated with respective parameter sets of a plurality of configurations of the UE;
receive control signaling indicating a switch from a first search space set group of the plurality of search space set groups to a second search space set group of the plurality of search space set groups; and
apply a parameter set of a first configuration of the plurality of configurations of the UE to the second search space set group based at least in part on the control signaling, wherein the second search space set group is associated with the first configuration.

2. The apparatus of claim 1, wherein the one or more instructions to receive the message are executable by the processor to cause the apparatus to:
receive the message indicating the plurality of search space set groups and indicating the plurality of configurations, wherein the plurality of configurations comprises a plurality of power saving parameter sets, a plurality of reliability parameter sets, or any combination thereof, and wherein the respective search space set groups are associated with a respective power saving parameter set or a respective reliability parameter set.

3. The apparatus of claim 1, wherein the one or more instructions to receive the message are executable by the processor to cause the apparatus to:
receive the message indicating the plurality of configurations, wherein a power saving parameter set of the plurality of configurations comprises a discontinuous reception timer parameter, a downlink offset parameter, an uplink offset parameter, an antenna parameter, or any combination thereof.

4. The apparatus of claim 1, wherein the one or more instructions to receive the message are executable by the processor to cause the apparatus to:
receive the message indicating the plurality of configurations, wherein a reliability parameter set of the plurality of configurations comprises a repetition parameter, a reference signal parameter, a transmission configuration indicator parameter, or any combination thereof.

5. The apparatus of claim 1, wherein the one or more instructions are further executable by the processor to cause the apparatus to:
receive the control signaling indicating the switch from the first search space set group to the second search space set group based at least in part on a change in traffic; and
apply the parameter set to the second search space set group based at least in part on the control signaling, wherein the second search space set group is associated with the first configuration, and wherein the parameter set comprises a power saving parameter set.

6. The apparatus of claim 1, wherein the one or more instructions are further executable by the processor to cause the apparatus to:
receive the control signaling indicating the switch from the first search space set group to the second search space set group based at least in part on a change in channel quality; and
apply the parameter set to the second search space set group based at least in part on the control signaling, wherein the second search space set group is associated with the first configuration, and wherein the parameter set comprises a reliability parameter set.

7. The apparatus of claim 1, wherein the one or more instructions to receive the message are executable by the processor to cause the apparatus to:
receive the message indicating the plurality of search space set groups, wherein the respective search space set groups are associated with respective scheduling request configuration groups of a plurality of scheduling request configuration groups.

8. The apparatus of claim 7, wherein the one or more instructions are further executable by the processor to cause the apparatus to:
receive downlink control information indicating the switch from the first search space set group to the second search space set group; and
apply a first scheduling request configuration group to the second search space set group based at least in part on the control signaling, wherein the second search space set group is associated with the first scheduling request configuration group.

9. The apparatus of claim 7, wherein the one or more instructions to receive the message are executable by the processor to cause the apparatus to:
receive the message indicating the plurality of search space set groups, wherein two or more search space set groups are associated with a respective scheduling request configuration group.

10. The apparatus of claim 1, wherein the one or more instructions are further executable by the processor to cause the apparatus to:
transmit a scheduling request via a channel associated with the scheduling request, wherein the scheduling request and the channel are indicated in a respective scheduling request configuration group.

11. An apparatus for wireless communication at a network entity, comprising:
a processor;
memory coupled with the processor; and
one or more instructions stored in the memory and executable by the processor to cause the apparatus to:
transmit a message indicating a plurality of search space set groups, wherein respective search space set groups of the plurality of search space set groups are associated with respective parameter sets of a plurality of configurations of a user equipment (UE); and
transmit control signaling indicating a switch from a first search space set group of the plurality of search space set groups to a second search space set group of the plurality of search space set groups.

12. The apparatus of claim 11, wherein the one or more instructions to transmit the message are executable by the processor to cause the apparatus to:
transmit the message indicating the plurality of search space set groups and indicating the plurality of configurations, wherein the plurality of configurations comprises a plurality of power saving parameter sets, a plurality of reliability parameter sets, or any combination thereof, and wherein the respective search space set groups are associated with a respective power saving parameter set or a respective reliability parameter set.

13. The apparatus of claim 11, wherein the one or more instructions to transmit the message are executable by the processor to cause the apparatus to:
transmit the message indicating the plurality of configurations, wherein a power saving parameter set of the plurality of configurations comprises a discontinuous reception timer parameter, a downlink offset parameter, an uplink offset parameter, an antenna parameter, or any combination thereof.

14. The apparatus of claim 11, wherein the one or more instructions to transmit the message are executable by the processor to cause the apparatus to:
transmit the message indicating the plurality of configurations, wherein a power saving parameter set of the plurality of configurations comprises a repetition parameter, a reference signal parameter, a transmission configuration indicator parameter, or any combination thereof.

15. The apparatus of claim 11, wherein the one or more instructions to transmit the control signaling are executable by the processor to cause the apparatus to:
transmit the control signaling indicating the switch from the first search space set group to the second search space set group based at least in part on a change in traffic.

16. The apparatus of claim 11, wherein the one or more instructions to transmit the control signaling are executable by the processor to cause the apparatus to:
transmit the control signaling indicating the switch from the first search space set group to the second search space set group based at least in part on a change in channel quality.

17. The apparatus of claim 11, wherein the one or more instructions to transmit the message are executable by the processor to cause the apparatus to:
transmit the message indicating the plurality of search space set groups, wherein the respective search space set groups are associated with respective scheduling request configuration groups of a plurality of scheduling request configuration groups.

18. The apparatus of claim 17, wherein the one or more instructions are further executable by the processor to cause the apparatus to:
transmit downlink control information indicating the switch from the first search space set group to the second search space set group.

19. The apparatus of claim 17, wherein the one or more instructions to transmit the message are executable by the processor to cause the apparatus to:
transmit the message indicating the plurality of search space set groups, wherein two or more search space set groups are associated with a respective scheduling request configuration group.

20. The apparatus of claim 11, wherein the one or more instructions are further executable by the processor to cause the apparatus to:
receive a scheduling request via a channel associated with the scheduling request, wherein the scheduling request and the channel are indicated in a respective scheduling request configuration group.

21. A method for wireless communication at a user equipment (UE), comprising:
receiving a message indicating a plurality of search space set groups, wherein respective search space set groups of the plurality of search space set groups are associated with respective parameter sets of a plurality of configurations of the UE;
receiving control signaling indicating a switch from a first search space set group of the plurality of search space set groups to a second search space set group of the plurality of search space set groups; and
applying a parameter set of a first configuration of the plurality of configurations of the UE to the second search space set group based at least in part on the control signaling, wherein the second search space set group is associated with the first configuration.

22. The method of claim 21, wherein receiving the message comprises:
receiving the message indicating the plurality of search space set groups and indicating the plurality of configurations, wherein the plurality of configurations comprises a plurality of power saving parameter sets, a plurality of reliability parameter sets, or any combination thereof, and wherein the respective search space set groups are associated with a respective power saving parameter set or a respective reliability parameter set.

23. The method of claim 21, wherein receiving the message comprises:
receiving the message indicating the plurality of configurations, wherein a power saving parameter set of the plurality of configurations comprises a discontinuous reception timer parameter, a downlink offset parameter, an uplink offset parameter, an antenna parameter, or any combination thereof.

24. The method of claim 21, wherein receiving the message comprises:
receiving the message indicating the plurality of configurations, wherein a reliability parameter set of the plurality of configurations comprises a repetition parameter, a reference signal parameter, a transmission configuration indicator parameter, or any combination thereof.

25. The method of claim 21, further comprising:
receiving the control signaling indicating the switch from the first search space set group to the second search space set group based at least in part on a change in traffic; and
applying the parameter set to the second search space set group based at least in part on the control signaling, wherein the second search space set group is associated with the first configuration, and wherein the parameter set comprises a power saving parameter set.

26. A method for wireless communication at a network entity, comprising:
transmitting a message indicating a plurality of search space set groups, wherein respective search space set groups of the plurality of search space set groups are associated with respective parameter sets of a plurality of configurations of a user equipment (UE); and
transmitting control signaling indicating a switch from a first search space set group of the plurality of search space set groups to a second search space set group of the plurality of search space set groups.

27. The method of claim 26, wherein transmitting the message comprises:
transmitting the message indicating the plurality of search space set groups and indicating the plurality of configurations, wherein the plurality of configurations comprises a plurality of power saving parameter sets, a plurality of reliability parameter sets, or any combination thereof, and wherein the respective search space set groups are associated with a respective power saving parameter set or a respective reliability parameter set.

28. The method of claim 26, wherein transmitting the message comprises:
transmitting the message indicating the plurality of configurations, wherein a power saving parameter set of the plurality of configurations comprises a discontinuous reception timer parameter, a downlink offset parameter, an uplink offset parameter, an antenna parameter, or any combination thereof.

29. The method of claim 26, wherein transmitting the message comprises:
transmitting the message indicating the plurality of configurations, wherein a power saving parameter set of the plurality of configurations comprises a repetition parameter, a reference signal parameter, a transmission configuration indicator parameter, or any combination thereof.

30. The method of claim 26, wherein transmitting the control signaling comprises:
transmitting the control signaling indicating the switch from the first search space set group to the second search space set group based at least in part on a change in traffic.
